(19) United States
(12) Patent Application Publication
(10) Pub. No.: US 2002/0188512 A1
(43) Pub. Date: Dec. 12, 2002

(54) Interaction system

(76) Inventors: Christopher George Harbron, Port Sunlinght (GB); Shail Patel, Port Sunlinght (GB)

Correspondence Address: MORGAN LEWIS & BOCKIUS LLP, 1111 PENNSYLVANIA AVENUE NW, WASHINGTON, DC, 20004, US

(21) Appl. No.: 10/153,729

(22) Filed: May 24, 2002

(30) Foreign Application Priority Data
May 30, 2001 (EP) 01304686.7

(51) Int. Cl. G06F 17/60

(52) U.S. Cl. 705/14; 705/26

(57) ABSTRACT

Method for improved customer interaction comprising the steps of:

(i) the customer electronically transfers a request to a coordinator indicating the desired items for obtaining and the desired promotional conditions for said transaction;

(ii) optionally the coordinator electronically interacts with one or more suppliers for receiving offers from said one or more suppliers;

(iii) the coordinator electronically transfers to the customer based on the requests of (a) and optionally the results of (b) one or more offers whereby each offer specifies: the items, the promotional conditions and if appropriate one or more requirements before the offer can be activated

(iv) the customer electronically transfers his acceptance of one or more of said offers to the coordinator.

### FIELD OF INVENTION

The present invention relates to an interaction system and to a method of efficient interaction between suppliers and consumers for example to allow the efficient obtaining of products and/or to ensure that consumers are offered the products according to their needs.

### BACKGROUND OF THE INVENTION

Recently several trends can be observed in the interface between consumer and supplier.

Firstly the Internet and other electronic means have opened the possibility for so-called electronic shopping. Several of these shopping possibilities are available for example via Amazon.com or Tesco.com. A problem with these traditional electronic shopping environments is that it is a supplier driven system and does not or only to a limited extend allow the adaptation of offered goods and conditions according to the customers wishes.

Secondly so-called e-commerce auction based systems are used more often; these systems allow the customer to bid for certain goods. These systems have the advantage that the customer can indicate the price he is prepared to offer, after which the supplier can decide whether said price is acceptable for the supplier. Such customer driven trading systems are often more preferred by the customers.

Thirdly with the rapid development of new media and communication channels, companies are increasingly searching for new methods to provide targeted information relating to their goods to select groups of consumers or to obtain from selected consumers information relating which may help to develop new products or services. However consumers are increasingly aware of the value of information especially the value of their personal data and opinions.

There is therefore a need to provide improved electronic systems which are capable to provide a customer driven trading process which is efficient and which provides the possibility to the supplier to obtain the desired information and which allows the consumer to obtain a compensation for this information.

It has now been found that an improved system for customer supplier interaction involves the centralized contact between the customer and one or more coordinators (preferably one coordinator), whereby the coordinator can be in contact with one or more suppliers in order to come to an acceptable offer for the customer.

Therefore the invention provides a coordinator system for coordinator-customer interaction said system comprising:

(a) display means for receiving a request by a customer indicating the desired items for obtaining and the desired promotional conditions for said transaction;

(b) optional interaction means between the coordinator and one or more suppliers for receiving offers from said one or more suppliers;

(c) input means for the coordinator to indicate based on the requests of (a) and optionally the results of (b) one or more offers whereby each offer specifies: the items, the promotional conditions and if appropriate one or more requirements before the offer can be activated;

(d) display means for displaying the response of the customer whereby one or more of the offers of (c) are accepted.

In another aspect the present invention provides a customer system for coordinator-customer interaction said system comprising:

(a) input means for the customer for indicating the desired items for obtaining and the desired promotional conditions for said transaction;

(b) display means which based on the input of (a) display one or more offers from one or more coordinator(s) whereby each offer specifies: the items, the promotional conditions and if appropriate one or more requirements before the offer can be activated;

(c) input means for the customer to confirm acceptance of one or more of the offers under (b).

The systems of the invention will now be described in more detail below.

### DETAILED DESCRIPTION OF THE INVENTION

Systems in accordance to the invention provide an efficient way of satisfying customer needs. Furthermore the system of the invention allows more or one supplier to provide each a part of the transaction, whereby the consumer only needs to interact with one coordinator. Furthermore the system of the invention allows the customer to indicate his desired promotional wishes while the supplier(s) can offer said desired promotions in exchange for information from the consumer.

In operation the systems can interact as follows: The customer system comprises input means for the customer indicating the desired items for obtaining and the desired promotional conditions for said transaction. Input means can be any suitable input means for example a keyboard for typing the desired transaction into a computer or other electronic device, microphones for example connected to a computer via voice recognition means, mobile phones with means to enter messages etc.

In a system of the invention the customer will not only clarify the type of goods desired to be obtained but also the conditions under which the transaction is acceptable. Such conditions can be several conditions related to the product for example price, keepability, quality etc or relating to promotional activities connected to the product for example discounts, free supplemental products etc or can also relate to the service connected to the product for example delivery conditions.

The advantage of this combined input of the desired products and the desired conditions is that only one transaction is needed between the customer and the coordinator and this single transaction fully clarifies the customer's wishes. This limited number of interactions involving the customer is especially desired because they significantly increase the efficiency of the shopping process and the risk of failure of electronic data transfer due to the often vulnerable customer systems or other networking problems can be minimized.

The details of the desired transaction will then be transferred from the customer system to the coordinator system. Such transfer can take any suitable form of data transfer for example via Internet, telephone, mobile telephone, satellite, infrared communications etc. Very conveniently the transfer of the details of the desired transaction will at least partly be via the Internet.

For the purpose of the invention one or more coordinators may be present. Preferably however the number of coordinators is low e.g. 1-5, most preferably only one coordinator is present. The invention will be described in detail with reference to one coordinator, adaptations to embrace multiple coordinator are however also embraced in the invention.

The details of the desired transaction will then be received and displayed at the coordinators' system. The coordinator then needs to decide whether it is possible to meet the desired transactional conditions.

In a first embodiment of the invention the coordinator has sufficient details ready at his disposal to judge if and how the desired transaction can be made. For example the coordinator can have a database available in which for a number of products and suppliers several possible promotional conditions are listed. In those circumstances the coordinator can, based on information available to him, formulate one or more offers whereby each offer specifies: the items, the promotional conditions and if appropriate one or more requirements before the offer can be activated.

In a second embodiment of the invention the coordinator desires to obtain additional information before a suitable reply can be made to the customer. In such embodiment the coordinator can interact with one or more suppliers to collect additional information concerning available products, promotional conditions and possible requirements before the offer can be activated. Again such interactions can be via any suitable technology, however again electronic interaction via the Internet is preferred for this purpose.

In a third embodiment of the invention the coordinator takes the role of supplier and formulates one or more offers which, if accepted by the customer will be satisfied by the coordinator.

If desired the coordinator can contact several suppliers for example to come to several possible offers. Alternatively the coordinator can contact several suppliers whereby each supplier only provides part of the desired transaction. For example a first supplier may supply the desired product; a second supplier may provide a discount on the product in exchange for a requirement before the discount can be activated.

Based on the input of the suppliers optionally supplemented by additional data e.g. as available in a database the coordinator can formulate one or more offers whereby each offer specifies: the items, the promotional conditions and if appropriate one or more requirements before the offer can be activated.

If desired the coordinator can also collect further information for example based on customer profiles (e.g. what type of customer is this and what type of offer would typically be considered as desirable) or other information sources.

Examples of items including in the transaction can be goods or services or combinations of these.

Examples of promotional conditions can be price discounts, free goods or samples, favorable delivery conditions, future discounts on the same or other items or combinations of these.

Examples of (optional) requirements which can be used before the offer can be activated are for example asking the customer to enter personal details or details from other potential customers into the system, asking the customer to fill in a questionnaire or asking the customer to watch or listen to a number of advertisements, the requirement for the customer to make their home web-page a page selected by the supplier, the requirement to purchase additional items, the requirement to subscribe to a service, the requirement to continue subscription to a service or combinations thereof. In exchange for such activities the offer can be activated.

Once the offers have been generated/inputted into the coordinator system the offers can be transferred to the customer system.

The customer can then review their offers on the display of the customer system and use the input means of the system to confirm acceptance of one or more of said offers.

If there are one or more requirements before the offer can be activated, the customer may suitable use the input and or display means for satisfying said requirements. For example if the requirements involve the inputting of data this can conveniently be done via the input means of the customer system and if the requirements involve the viewing of data, for example the viewing of advertisements this can conveniently be done on the display means of the customer system.

After the acceptance of one or more of the offers the offer may be progressed via any suitable process.

In one possible embodiment the items to be delivered will be delivered to the customer via the coordinator which can either act as supplier or obtain the items via one or more suppliers.

In another possible embodiment the items can be delivered to the customer directly by the relevant suppliers possibly without involvement of the coordinator. If more than one supplier is involved in the offer then both suppliers may independently deliver their part of the transaction to the customer or the suppliers may coordinate their activities for example via the coordinator of otherwise.

The payment connected to the transaction can be arranged similarly either via contacts between the customer and the coordinator and/or one or more of the suppliers.

For some situations the system of the invention will involve the payment of one supplier to another supplier. For example if a first supplier provides an item to the customer and a second supplier provides a discount on the price of said item in exchange for the filling in of a questionnaire. In such situation the payment transaction can again take any suitable form.

For example in a first embodiment the customer will pay the discounted price to the coordinator. The second supplier will pay the discount to the coordinator and the total of discounted price plus discount will then be transferred from the coordinator to the first supplier.

Alternatively the customer can pay the discounted price to the first supplier and the second supplier will pay the discount to the first supplier.

It will be apparent to the skilled person that multiple arrangements may be suitable for delivering and payment of the items.

For improving the reliability of the system it may often be advantageous if the coordinator is involved in the delivery and/or payment process. For this the coordinator system can advantageously include storage and/or display means for monitoring the delivery and/or payment related to the transaction.

The invention will be further illustrated by means of the following examples.

### EXAMPLE I

A customer is interested to obtain a horoscope. Traditionally the price of a full horoscope via iVillage is $10. The customer is however interested in a full horoscope but does not want to pay for this.

Therefore the customer enters into its customer system a request for a full horoscope for free. For this case the system involves an Internet enabled program on his personal computer.

The request by the customer is then transferred via the Internet to the coordinator who reviews the request at the display of his coordinator system.

The coordinator then subsequently gets in electronic contact via the Internet to a number of potential sponsors to see if they are prepared to pay for the horoscope if some sort of action is undertaken by the customer.

Such electronic interaction can also involve the transfer of information concerning the customer such that the sponsors can judge whether their sponsorship would be appropriate.

In this case the coordinator will put the request to several potential sponsors if they are willing to sponsor a free full horoscope for a 67-year-old female living in rural England.

Sponsor 1 indicates then to the coordinator that he is not interested to sponsor this because his target group is of lower age.

Sponsor 2 indicated to the coordinator that he is willing to sponsor the full horoscope if the customer is prepared to make the web-site of Sponsor 2 her homepage.

Sponsor 3 indicates that he is willing to sponsor the full horoscope provided he may add the name and personal details of the customer to a database for future marketing activities. Based on the input of the potential sponsors the coordinator formulates on its coordinator system two offers to the customer corresponding to the requirements of sponsors 2 and 3 as above. The offers are then transferred to the customer system.

The customer reviews the offers at the display of the customer system and decides to accept the offer of sponsor 3.

The personal details of the customer are now transferred from the coordinator to sponsor 3. In exchange, sponsor 3 pays $10 to the coordinator and the coordinator uses this money to order a free horoscope for the customer via iVillage.

### EXAMPLE 2

A customer is interested in buying champagne at half price. Via his customer system he puts the request to the coordinator system which in this case is a large supermarket chain.

The supermarket identifies the champagne manufacturers and offers them a trade: information about the consumer in return for the supply of a bottle of half price champagne. Two sponsors reply that they are willing to supply the bottle. The supermarket then offers the two champagnes at half price to the customer provided the personal details can be passed on and provided at least £100 is spend in the electronic shopping environment of the supermarket. The two offers are inputted in the coordinator system and transferred to the customer system.

The customer reviews at its display the two offers and decides to accept both offers. He subsequently activates the offer by shopping for at least £200 in the electronic shopping environment of the supermarket plus by giving permission that his personal details may be transferred to the champagne suppliers.

Once the offers have been accepted and activated the supermarket will deliver the shopping goods including the two champagne bottles to the customer. The supermarket will receive the payment. Subsequently each of the two champagne suppliers will receive the personal details and half of the price of their champagne.

### EXAMPLE 3

A customer is willing to watch interactive digital TV, and chooses a film he wants to watch.

His request to the customer system is that he wants to hire a movie but he wants a discounted pizza to go with it plus that he is prepared to watch advertisements while waiting for the pizza, provided it is it is to be delivered within 15 minutes after starting the advertisements. The request is then transferred via the Internet to the coordinator system.

The coordinator then approaches Sky Open who is willing to identify an appropriate set of advertisements and negotiates automatically whether the sponsoring companies are prepared to share the price of a pizza, given the information that the customer is a 22 year old skater.

Based on the input of Sky Open the coordinator formulates an offer to the coordinator system specifying the goods to be supplied (pizza and film), the price (discounted pizza) and the conditions before the offer can be activated (the watching of a specific series of tv commercials). The offer is then transferred to the customer.

The customer reviews the offer at the display of its customer system and inputs into the sytems his acceptance of the offer. The acceptance is via the Internet transferred to the coordinator system.

The transaction is then finalised by the coordinator as follows: the film and series of advertisements will be sent to the interactive TV of the customer by Sky Open. Furthermore Sky Open will pay to the coordinator the discount to the price of the pizza. The coordinator then ensures that a pizza is delivered to the customer at the desired moment.

1. A coordinator system for coordinator-customer interaction said system comprising:
(a) display means for receiving a request by a customer indicating the desired items for obtaining and the desired promotional conditions for said transaction;
(b) optional interaction means between the coordinator and one or more suppliers for receiving offers from said one or more suppliers;
(c) input means for the coordinator to indicate based on the requests of (a) and optionally the results of (b) one or more offers whereby each offer specifies: the items, the promotional conditions and if appropriate one or more requirements before the offer can be activated;
(d) display means for displaying the response of the customer whereby one or more of the offers of (c) are accepted.

2. A customer system for coordinator-customer interaction said system comprising:
(a) input means for the customer for indicating the desired items for obtaining and the desired promotional conditions for said transaction;
(b) display means which based on the input of (a) display one or more offers from the coordinator whereby each offer specifies: the items, the promotional conditions and if appropriate one or more requirements before the offer can be activated;
(c) input means for the customer to confirm acceptance of one or more of the offers under (b).

3. System according to claim 1 or claim 2, wherein at least one of the offers is based on a combination of at least 2 partial offers from different suppliers.

4. System according to claim 1 or 2, wherein the promotional conditions are selected from the group price discounts, free goods or samples, favorable delivery conditions, future discounts on the same or other items or combinations of these.

5. System according to claim 1 or 2 being an electronic system

6. System according to claim 1 or 2 wherein at least one requirement is present before the offer can be activated.

7. System according to claim 6 wherein the requirements are selected from the requirement for the customer to enter personal details or personal details of other potential customers into the system, the requirement for the customer to fill in a questionnaire, the requirement to the customer to watch or listen to a number advertisements, the requirement for the customer to make their home web-page a page selected by the supplier, the requirement to purchase additional item, the requirement to subscribe to a service, the requirement to continue subscription to a service, or combinations thereof.

8. Method for improved customer interaction comprising the steps of:
(i) the customer electronically transfers a request to a coordinator indicating the desired items for obtaining and the desired promotional conditions for said transaction;
(ii) optionally the coordinator electronically interacts with one or more suppliers for receiving offers from said one or more suppliers;
(iii) the coordinator electronically transfers to the customer based on the requests of (a) and optionally the results of (b) one or more offers whereby each offer specifies: the items, the promotional conditions and if appropriate one or more requirements before the offer can be activated
(iv) the customer electronically transfers his acceptance of one or more of said offers to the coordinator.
